(19) United States
(12) Patent Application Publication
(10) Pub. No.: US 2004/0032428 A1
(43) Pub. Date: Feb. 19, 2004

(54) Document including computer graphical user interface element, method of preparing same, computer system and method including same

(76) Inventors: Maurizio Pilu, Bristol (GB); Stephen Bernard Pollard, Uley Nr Dursley (GB); David Mark Frohlich, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/460,675

(22) Filed: Jun. 13, 2003

(30) Foreign Application Priority Data
Jun. 13, 2002 (GB) 0213531.7

(51) Int. Cl. G09G 5/00

(52) U.S. Cl. 345/764

(57) ABSTRACT

A printed document is an interface with a computer. A camera generates a video signal representing an image of the printed document. A processor linked to the camera processes an image of the printed document and a finger or pointing implement pointing to a region of the printed document. The processor recognizes when a graphical user interface element within the captured image is selected by the user pointing to the user interface element on the printed document by determining the region on the page that is pointed to by the finger or pointing implement and determining from a memory the identity of the user interface element, if any, that corresponds to the region of the printed page pointed to by the finger or pointing implement and then triggers an operation represented by that graphical user interface element.

### FIELD OF THE INVENTION

The present invention relates to a method and apparatus in which a printed document includes at least one graphical user interface (GUI) element for controlling how a computer processes other information included on the document, to a document including such a graphical user interface element and to a method of preparing such a document.

### BACKGROUND TO THE INVENTION

Over the decades since electronic computers were first invented, office practices have become dominated by them and information handling is now very heavily based in the electronic domain of the computer. The vast majority of documents are prepared, adapted, stored and even read in electronic form on computer display screens. Furthermore, in parallel to this, computer interface technology has advanced from there being a predominantly physical interface with the computer using punched cards, keypads or keyboards for data entry—to the extensive present-day reliance on use of cursor moving devices such as the mouse for interacting with the screen-displayed essentially electronic interface known as the Graphical User Interface (GUI) that is a paradigm that is in use universally in applications such as Windows®. The Graphical User Interface can be regarded as a virtual interface in which the individual GUI elements comprise operator key icons or textual identifiers that replace the pushbutton keys of a physical keyboard.

The drive towards handling documents electronically and also representing hardware computer interfaces in a predominantly electronic form has been relentless since, amongst other obvious benefits, software implementations of hardware occupy no space and may be many orders of magnitude cheaper to produce. Nevertheless, electronic versions of documents and virtual interfaces do not readily suit the ergonomic needs of all users and uses. For some tasks, reading included, paper-based documents are much more user friendly than screen-based documents. Hard copy paper versions of electronic documents are still preferred by many for proof-reading or general reviews, since they are of optimally high resolution and flicker-free and less liable to give the reader eye-strain, for example.

In recent years the Xerox Corporation have been in the vanguard of developments to better integrate beneficial elements of paper based documents with their electronic counterpart. In particular they have sought to develop interface systems that heighten the level of physical interactivity and make use of computers to enhance paper-based operations.

Their European patent EP 0,622,722 describes a system in which an original paper document lying on a work surface is scanned by an overhead camera linked to a processor/computer to monitor the user's interaction with text or images on the paper document. An action such as pointing to an area of the paper document can be used to select and manipulate an image taken by the camera of the document and the image or a manipulated form of it is then projected back onto the work surface as a copy or modified copy. The Xerox interactive copying system is suited to this role but is not optimally straightforward, compact, cost efficient and well adapted for other paper-based activities.

### SUMMARY OF THE INVENTION

A first aspect of the present invention is directed to a method of processing information associated with content on a document, wherein the document includes at least one graphical user interface element for controlling a computer function. Different graphical user interface elements are associated with controlling different computer functions. The method comprises converting an optical image of the document into a signal representing the graphical user interface element and other content of the document. The computer processes at least some information associated with the content of the document, as included in the signal, based on a selected graphical user interface element on the document, as included in the signal.

Another aspect of the invention relates to the combination of (1) a document including at least one graphical user interface element for controlling a computer function and other content, wherein different graphical user interface elements are associated with controlling different computer functions; (2) an optical image converter for generating a signal in response to optical images on the document, wherein the signal represents the graphical user interface element and the other content of the document; and (3) a processor adapted to be responsive to the signal for processing at least some information associated with the other content of the document based on a selected graphical user interface element of the document, as included in the signal.

A further aspect of the invention relates to an apparatus for use with plural documents, each including at least one graphical user interface element for controlling a computer function and other content, wherein different graphical user interface elements are associated with controlling different computer functions. The apparatus comprises (1) an optical image converter for generating a signal in response to optical images on the document, wherein the signal represents the graphical user interface element and the other content of the document; and (2) a processor adapted to be responsive to the signal for processing at least some information associated with the other content of the document based on a selected graphical user interface element of the document, as included in the signal.

An additional aspect of the invention relates to a method of preparing a document including visual content to be processed by a computer and at least one graphical user interface element for controlling processing of information associated with the content by the computer. The method comprises the steps of (1) applying the visual content to the document, and (2) applying at least one graphical user interface element to the document. The at least one graphical user interface element is selected from a plurality of graphical user interface elements, each associated with a different function which can be performed by the computer on information associated with the visual content included in the document.

An added aspect of the invention relates to a document for use with a computer, wherein the document comprises (1) at least one graphical user interface element and (2) a visual content portion. The graphical user interface element is distinct from the visual information and is such as to provide control of how the computer processes information associated with the visual content on the document.

Preferably, the document includes a plurality of the graphical user interface elements. One of the graphical user interface elements is selected by pointing. The signal includes an indication of the pointing. At least some of the information associated with the document content is processed in response to the pointed to graphical user interface element, as included in the signal.

In one embodiment, the pointing step is performed with a pointer and the signal includes an indication of the location of the pointer. The processing is responsive to the indication of the pointer location so at least some information associated with the content of the document is processed based on the location of the pointer on the selected graphical user interface element and the selected graphical user interface element.

In a second embodiment, the pointing step is performed by a finger of a user, so that the signal includes an indication of the location of the finger. The processing is responsive to the indication of the finger location so at least some information associated with the content of the document is processed based on the location of the finger on the selected graphical user interface element and the selected graphical user interface element.

In a first embodiment, the at least one graphical user interface element is printed in an area outside margins associated with the content of the document. In this embodiment, graphical user interface elements are processed only in the portion of the signal associated with regions outside the margin.

As noted above, the at least one user interface element is printed in the areas outside the margins of the primary information content of the document. The graphical user interface element is printed on the document prior to printing the primary information content on the document. The user interface printed on the document is preferably configured by using an editor which is preferably an integral part of the same editor by means of which the primary information content of the document is configured prior to being printed.

In a preferred arrangement, the document includes a plurality of distinct position indicating visual indicia that are included in the signal. The location of the area outside the location of the margin where the at least one graphical user interface is located is determined by processing the portion of the signal indicative of the position indicating indicia.

In a second embodiment, the graphical user interface element can be of a select type, for example a type that represents a command for an action such as “play audio” or “play video.” Such a graphical user interface is preferably printed within the margins of the primary information content of the document, instead of outside the margin. This, arrangement provides positioning of an action graphical user interface element close to or overlying corresponding text or other information on the printed document. For example a graphical user interface element entitled “play audio” is preferably over or adjacent to a picture which, when read by the computer, causes the computer to output an audio signal enabling a user to hear commentary or sounds associated with that picture.

Advantageously the printed graphical user interface element is configurable to suit the primary contents of the document page, preferably with different user interface elements to suit different types of primary information content.

Since the combination of the printed graphical user interface element with the primary information content may lead to repositioning of the text/information content of the document for printing, it is particularly desirable that the method of preparation of the printed document includes use of the editor to repaginate the original content to allow for this.

Where the printed user interface is configurable it is particularly advantageous to embed a definition of the printed user interface configuration into the document itself or at least to include on the document a link to a definition of the printed user interface configuration. This facilitates subsequent reprinting of the document with the same user interface configuration by recipients of the printed document.

### BRIEF DESCRIPTION OF THE DRAWINGS

A preferred embodiment of the present invention will now be more particular described, by way of example, with reference to the accompanying drawings, Wherein:

FIG. 1 is a simple system architecture diagram;

FIG. 2 is a plan view of a printed paper document with calibration marks and a page identification mark;

FIG. 3 is a close-up plan view of one of the calibration marks;

FIG. 4 is a close-up plan view of the page identification mark comprising a two-dimensional bar code;

FIG. 5 is a flow chart demonstrating the operation of the system; and

FIGS. 6A, 6B and 6C are plan views of printed paper documents bearing GUI elements.

### DESCRIPTION OF THE PREFERRED EMBODIMENT

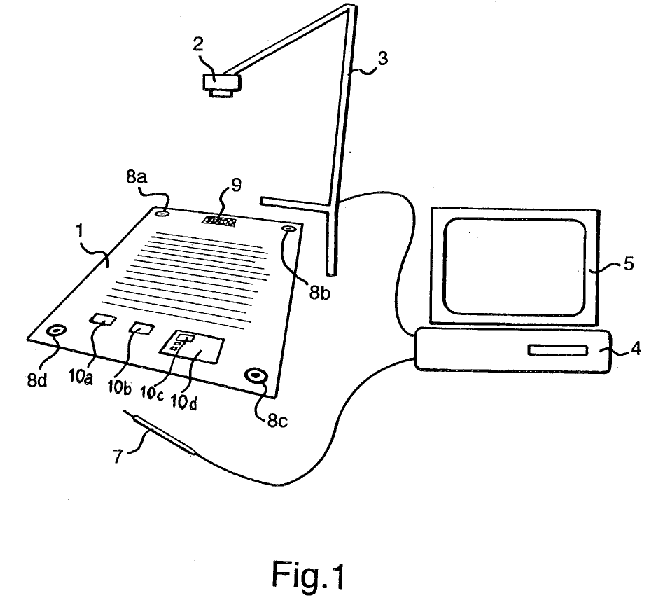

The system/apparatus of FIG. 1 comprises, in combination, a printed or scribed document 1, in this case a sheet of paper that is, for example, a printed page from a holiday brochure or a printed web page; a camera 2, preferably a digital video camera, which is held above the document 1 by a stand 3 and focuses down on the document 1; a processor/computer 4 to which the camera 2 is linked, the computer suitably being a conventional personal computer (PC) having an associated visual display unit (VDU)/monitor 6; and a pointer 7 with a pressure sensitive tip or other selector button at its tip and which is linked to the computer 4. Camera 2 converts an optical image of the document, including position indicia, at least one graphical user interface element and text or other data on the document into a signal (e.g., a video signal). Computer 4 responds to the signal to process information associated with at least some of the text or other data based on a selected one of the graphical user interface elements on document 1.

The document 1 differs from a conventional printed brochure page or web page because document 1 has printed on it a graphical user interface element. In the preferred embodiment the GUI comprises a set of user interface elements (hereafter GUI elements) 10a-10d, here shown provided on the bottom of the page in the margin below the text on the page. A GUI in the context of this document is a GUI placed on the printed document to activate a function of a computer and is thus different from a conventional on-screen GUI.

The document 1 also includes (preferably by printing) (1) a set of four calibration marks 8a-8d, one mark 8a-d proximate each corner of the page, and (2) a two-dimensional bar code 9 which serves as a readily machine-readable page identifier mark. Bar code 9 is located at the top of the document 1, substantially centrally between the top edge pair of calibration marks 8a, 8b.

The printed GUI elements 10a-d, button-shaped icons, are also easily distinguished from the other images on document 1. Each of elements 10a-d is labelled with a word or image to represent a specific computer action such as deleting, annotating, sending, or saving data. Elements 10a-d can also command a computer to perform other actions, e.g., produce audio, music or pictures associated with the text on document. Each element 10a-d corresponds to a different computer action and is positioned on the printed document 1 at a location that is known to the computer 4, as discussed in further detail later, so that the computer 4 activates the subroutine for the GUI element in response to that position on the document 1 being pointed to and selected by a user. Because computer 4 only looks for the GUI elements outside the margin of document 1 where the text or other data are located, computer operation is not hindered, when processing document 1, by looking for both text and GUI elements at the same time.

Partly for this reason it is important for the system to be set up to reliably register the pose of the printed document 1 within the field of view of the camera 2, a result achieved with the aid of marks associated with text on document 1, 8a-8d.

The calibration marks 8a-8d are position reference marks that are easily differentiable and localizable by the processor of the computer 4 in the electronic images of the document 1 captured by the overhead camera 2.

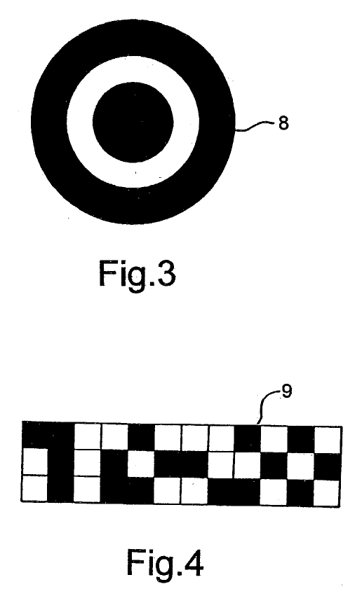

The illustrated calibration marks 8a-8d are simple and robust, each comprising a black circle on a white background with an additional coaxial black circle around it as shown in FIG. 3, to provide three image regions that share a common center (central black disc with outer white and black rings). This relationship is approximately preserved under moderate perspective projection as is the case when the target is viewed obliquely.

It is easy to robustly locate such a mark 8 in the image taken from the camera 2. The black and white regions are made explicit by thresholding the image using either a global or preferably a locally adaptive thresholding technique. Examples of such techniques are described in:

Gonzalez R. & Woods R. Digital Image Processing, Addison-Wesley, 1992, pages 443-455; and Rosenfeld A. & Kak A. Digital Picture Processing (second edition), Volume 2, Academic Press, 1982, pages 61-73.

After thresholding, the pixels that make up each connected black or white region in the image are made explicit using a component labelling technique. Methods of performing connected component labelling/analysis both recursively and serially on a raster by raster basis are described in: Jain R., Kasturi R. & Schunk B. Machine Vision, McGraw-Hill, 1995, pages 42-47 and Rosenfeld A. & Kak A. Digital Picture Processing (second edition), Volume 2, Academic Press, 1982, pages 240-250.

Such methods explicitly replace each component pixel with a unique label.

Black and white components can be found through separate applications of a simple component labelling technique. Alternatively it is possible to identify both black and white components independently in a single pass through the image. It is also possible to identify components implicitly as they evolve on a raster by raster basis keeping only statistics associated with the pixels of the individual connected components (this requires extra storage to manage the labelling of each component).

In either case what is finally required is the center of gravity of the pixels that make up each component and statistics on its horizontal and vertical extent. Components that are either too large or too small can be immediately eliminated. Of the remainder what we require are those which approximately share the same center of gravity and for which the ratio of their horizontal to vertical dimensions agrees roughly with those in the calibration mark 8. An appropriate black, white, black combination of components identifies a calibration mark 8 in the image. The combined center of gravity (weighted by the number of pixels in each component) gives the final location of the calibration mark 8.

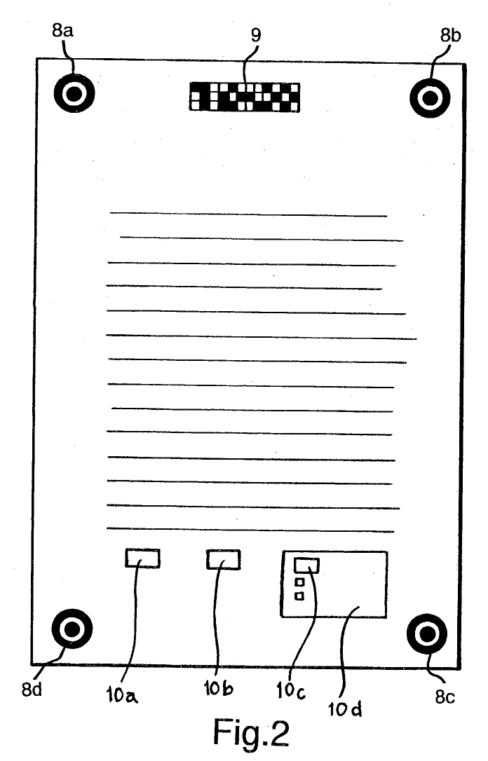

The minimum physical size of the calibration mark 8 depends upon the resolution of the sensor/camera 2. Typically the whole calibration mark 8 must be more than about 60 pixels in diameter. For a three megapixel (MP) camera imaging an A4 document there are about 180 pixels to the inch so a 60 pixel target about covers ⅓^{rd} of an inch. It is particularly convenient to arrange four such calibration marks 8a-d at the corners of the page to form a rectangle as shown in the illustrated embodiment of FIG. 2.

For the simple case of frontal-parallel (i.e., perpendicular) viewing it is only necessary to correctly identify two calibration marks 8 in order to determine the location, orientation and scale of the documents. Furthermore for a camera 2 with a fixed viewing distance the scale of the document 1 is also fixed (in practice the thickness of the document, or pile of documents, affects the viewing distance and, therefore, the scale of the document).

In the general case the position of two known calibration marks 8 in the image is used to compute a transformation from image co-ordinates to those of the document 1 (e.g. origin at the top left hand corner with the x and y axes aligned with the short and long sides of the document respectively). The transformation is of the form:

$$[ \begin{matrix}{X}^{′} \\ {Y}^{′} \\ 1\end{matrix} ] = [ \begin{matrix}k cos θ & - sin θ & {t}_{x} \\ sin θ & k cos θ & {t}_{y} \\ 0 & 0 & 1\end{matrix} ] [ \begin{matrix}X \\ Y \\ 1\end{matrix} ]$$

Where (X, Y) is a point in the image and (X′, Y′) is the corresponding location on the document (1) with respect to the document page co-ordinate system. For these simple 2D displacements the transform has three components: an angle θ a translation (tₓ, t_{y}) and an overall scale factor k. The three components can be computed from two matched points and the imaginary line between them using standard techniques (see for example: HYPER: A New Approach for the Recognition and Positioning of Two-Dimensional Objects, IEEE Trans. Pattern Analysis and Machine Intelligence, Volume 8, No. 1, January 1986, pages 44-54).

With just two identical calibration marks 8a, 8b it is usually difficult to determine whether the calibration marks lie on the left or right of the document or the top and bottom of a rotated document 1 (or in fact at opposite diagonal corners). One solution is to use non-identical marks 8, for example, with different numbers of rings and/or opposite polarities (black and white ring order). This way any two marks 8 can be identified uniquely.

Alternatively a third mark 8 can be used to prevent an ambiguity. Three marks 8 must form an L-shape with the aspect ratio of the document 1. Only a 180 degree ambiguity then exists for which the document 1 would be inverted for the user and thus highly unlikely to arise.

Where the viewing direction is oblique (allowing the document 1 surface to be non-fronto-parallel or extra design freedom in the camera 2 rig) it is necessary to identify all four marks 8a-8d in order to compute a transformation between the viewed image co-ordinates and the document 1 page co-ordinates.

The perspective projection of the planar document 1 page into the image undergoes the following transformation:

$$[ \begin{matrix}x \\ y \\ w\end{matrix} ] = [ \begin{matrix}a & b & c \\ b & e & f \\ g & h & 1\end{matrix} ] [ \begin{matrix}{X}^{′} \\ {Y}^{′} \\ 1\end{matrix} ]$$

Where X′=x/w and Y′=y/w.

Once the transformation has been computed, the transformation can be used to locate the document page identifier bar code 9 from the expected co-ordinates for its location that are held in a register in the computer 4. Also the computed transformation is used to map events (e.g. pointing) in the image to events on the page (in its electronic form).

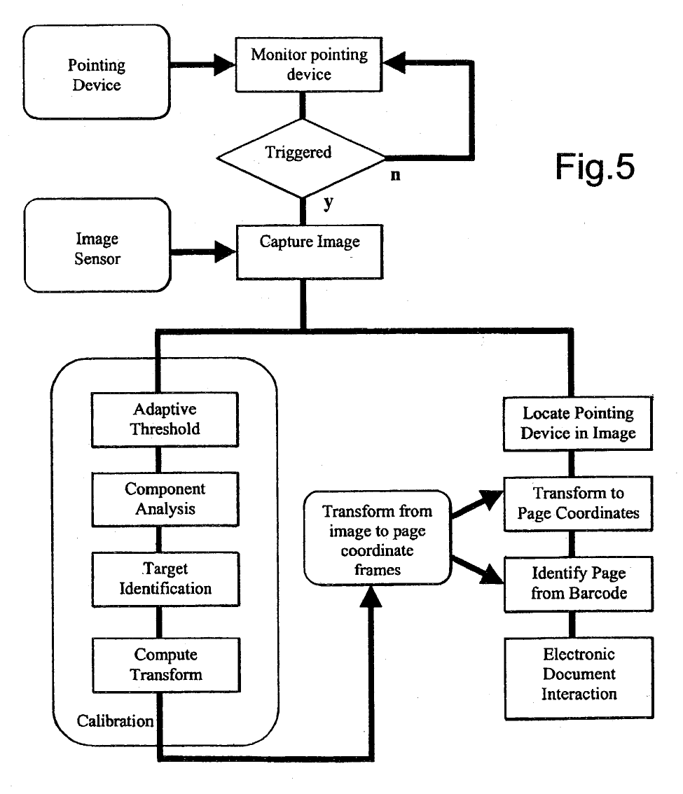

FIG. 5 is a flow chart of a sequence of actions that are suitably carried out by the system of FIG. 1 in response to a user triggering a switch including a pointing device 9 for pointing at the document 1 within the field of view of the camera 2 image sensor. Triggering the switch causes camera 2 to capture of an image, which is computer 4 then processes.

As noted above, in the embodiment of FIG. 1 the apparatus comprises a tethered pointer 7 with a pressure sensor or other switch at its tip that is used to trigger capture of an image by the camera 2 when the document 1 is tapped with the tip of pointer 7. Computer 4 responds to the image that camera 2 captures for (1) calibration to calculate the mapping from image to page co-ordinates; (2) page identification from the barcodes; and (3) determining the current location of the end of the pointer 7.

The calibration and page identification operations are best performed in advance of mapping any pointing movements in order to reduce system delay.

The easiest way to determine the location of the tip of pointer 7 is to use a readily differentiated locatable and identifiable special marker at the tip. However, other automatic methods for recognizing long pointed objects could be made to work. Indeed, pointing can be done using the operator's finger provided the system is adapted to recognize the operator's finger and respond to a signal such as tapping or other distinctive movement of the finger or operation of a separate switch to trigger image capture.

In using the system, having placed the printed or scribed document 1 in the field of view of camera 2 and suitably first allowed the processor 4 to carry out the calibration as described above, the user points to one of the areas on the document 1 that is marked with a GUI element 10a-d to trigger operation of an associated subroutine in the computer 4.

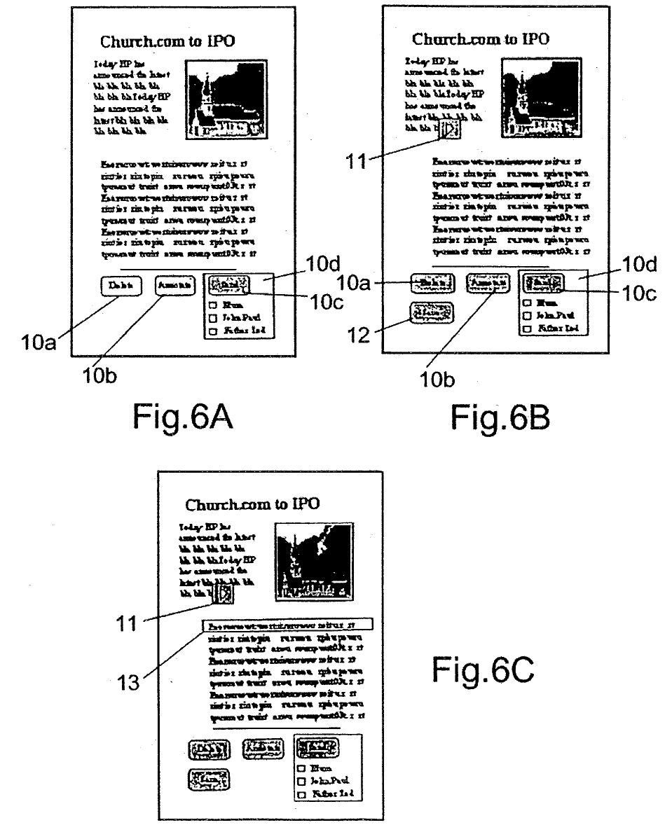

In the example of FIG. 6a, the document 1 is a printed page of news that includes printed GUI elements 10a-c at its foot, i.e., beyond the printed page margin. The first GUI element 10a (the first GUI element reading from left to right) represents a “DELETE” button, the next GUI element 10b represents an “ANNOTATE” button, the third GUI element 10c represents a “SEND” button and is positioned within a field 10d on the page that is marked with three blank tick boxes adjacent names of three alternative addressees for the user to select by marking with a pen one or more addressees to whom an electronic copy of the page 1 is to be sent. Computer 4 responds to the pointed to (i.e., selected) GUI element 10a, 10b or 10c in the signal from camera 2 and operates on the text or other data on the printed page of document or page 1 (as included in the signal from camera 2) based on the selected GUI element.

By marking one or more of the tick boxes with a pen and pointing to the SEND button 10c within the field of view of the camera 2 and triggering image capture by tapping the tip of the pointer 7 on the page 1 at that region 10c, the camera 2 captures an image of the tip of the pointer 7 overlying the page 1 and pointing to that SEND button 10c. The processor 4 recognises the tip of the pointer 7 in the captured image and references a two dimensional hit table/look-up table within a memory of the processor 4 to establish which GUI element 10a-c has been selected by the user from the X-Y co-ordinates of the position of the pointer tip within the captured image of the page 1. The subroutine for that GUI element 10c is activated in response to the ‘hit’ and the processor 4 establishes from the captured image which tick box, if any, has been marked and sends an electronic copy of the page 1 to the, or each, selected addressee.

Should the user select, instead of the SEND button 10c, the DELETE button 10a, the processor 4 in the same manner determines which GUI element has been selected and activates the associated sub-routine to carry out the GUI element-triggered action; i.e., in this situation to delete relevant stored information in the text on the page from the memory of the computer 4.

Selection of the printed GUI element 10b representing an “ANNOTATE” button activates a sub-routine in the computer 4 to carry out an annotation function. An exemplary annotation function computer 4 performs is adding an electronic tag to the electronic copy of the captured document 1. Another annotation function computer 4 performs in response to one of the GUI elements is storing details of any manuscript amendments/notes made by the user on the printed document 1 and captured as an image by the camera 2.

The printed document 1 of FIG. 6B includes a further printed GUI element 12 that represents a “SAVE” button to trigger operation of a sub-routine for saving the captured image of the printed document 1 to a non-volatile memory in the computer 4. This printed document 1 of FIG. 6B also includes a printed GUI element 11 that, unlike the other elements 10a-c and 12, is located within the body of the text/drawings of the printed document 1 and not beyond its margin. The GUI element 11 represents a “PLAYING” button to trigger fetching and playing of a related audio or video sequence. Superimposing the “PLAY” GUI element 11 on the text causes element 11 to be more readily discriminated from the more basic control elements 10a-c and 12, and be more directly visually associated with the aspects of the printed document 1 to which it relates, makes its use far more intuitive to greatly enhance the efficiency of the printed document 1 as an interface to the computer.

FIG. 6C is an example of printed document 1 similar to that in FIG. 6B but in which part of the text has been ringmarked by way an annotation made by the user. A sub-routine of computer 4 is triggered by the ANNOTATE button 10b to compare an image of the printed document 1 prior to annotation with an image following annotation to detect the modifications made to the document by the user.

The printed document 1 of FIG. 6C has a printed GUI to enable the document to be used in the manner described above, whether with the same computer or a remote computer. Document 1 is suitably set up by using the printer driver or the editor of computer 4 which is modified to add the GUI element to the printed document 1, suitably in substantially the same way as is conventionally done with headers or footers. The user interface is embedded in the document using ‘user data’ fields available in many standard formats, such as TIFF or PDF documents.

The editor is arranged to print the GUI, and store in the document format the GUI elements and their associated actions. The editor is not simply programmed to print the GUI but is arranged to specifically place and configure each GUI element into the printed documents, such that when a printed document is later to be used as a printed graphic user interface, the computer system 2 is able to recognize the actions associated with each GUI element. Accordingly, when a user places the printed document 1 under camera 2, computer 4 recognizes the document and downloads the electronic version of the printed document 1 and carries out the actions associated with the GUI element 10a-d buttons marked on the printed document 1. In response to the file associated with document 1 being distributed to another person for remote use, the same pointing action on that other person's printed version with its graphic user interface leads to the same GUI effect.

The definition of the configured printed graphic user interface is embedded in the document itself, facilitating redistribution or storage. A link can be included in the document to link to a definition of the printed GUI configuration.

The printed GUI can be page specific (e.g. could change with respect to the content of the page) giving a further reason for suitably having a facility to store the configured printed graphic user interface definition in the document.

Further in setting up a printed GUI, the system/method/editor can be arranged to provide a default GUI specific to a page content. This can suitably, for example, differentiate between a picture from a document or an audio photo. This default GUI could be specialised by manual configuration using a facility for the manual configuration in the editor if desired.

In preparing the printed document 1 with the printed GUI, the editor is, in the preferred embodiment, arranged to repaginate the original content for the document to allow for the added GUI element content.

Although in the preferred embodiment the printed document 1 is shown as having a discretely located page identifier/barcode 9 and calibration marks 8, the role of these marks can be performed by markings within or added to the printed Graphic User Interface, suitably without the user being aware.

1. A method of processing information associated with content on a document, the document also including at least one graphical user interface element for controlling a computer function, different graphical user interface elements being associated with controlling different computer functions, the method comprising:
converting an optical image of the document into a signal representing the graphical user interface element and other content on the document; and
processing at least some information associated with the other content of the document as included in the signal based on a selected graphical user interface element on the document, as included in the signal, the processing being performed by the computer in response to the signal.

2. The method of claim 1 wherein the document includes a plurality of the graphical user interface elements, the method further comprising: (a) selecting one of the graphical user interface elements by pointing, the signal including an indication of the pointing, and (b) processing, with the computer, at least some of the other content in response to the pointed to graphical user interface element, as included in the signal.

3. The method of claim 2 wherein the pointing step is performed with a pointer, the signal including an indication of the location of the pointer, the processing being responsive to the indication of the pointer location so information associated with at least some of the other content of the document is processed based on the location of the pointer on the selected graphical user interface element and the selected graphical user interface element.

4. The method of claim 2 wherein the pointing step is performed by a finger of a user, so that the signal includes an indication of the location of the finger, the processing being responsive to the indication of the finger location so information associated with at least some of the other content of the document is processed based on the location of the finger on the selected graphical user interface element and the selected graphical user interface element.

5. The method of claim 1 wherein the at least one graphical user interface element is printed in an area outside margins associated with the other content of the document, and further including processing graphical user interface elements only in the portion of the signal associated with regions outside the margin.

6. The method of claim 5 wherein the document includes a plurality of distinct position indicating visual indicia that are included in the signal, determining the location of the area outside the location of the margin where the at least one graphical user interface is located by processing the portion of the signal indicative of the position indicating indicia.

7. The method of claim 1 wherein the at least one graphical user interface element is printed in an area inside margins including the other content of the document, and causing the computer to process information associated with a portion of the other content adjacent the graphical user interface and element.

8. In combination,
a document including (a) at least one graphical user interface element for controlling a computer function and (b) other content, different graphical user interface elements being associated with controlling different computer functions,
an optical image converter for generating a signal in response to optical images on the document, the signal representing the graphical user interface element and the other content of the document; and
a processor adapted to be responsive to the signal for processing information associated with at least some of the other content of the document based on a selected graphical user interface element of the document, as included in the signal.

9. The combination of claim 8 wherein the document includes a plurality of the graphical user interface elements, one of the graphical user interface elements being adapted to be selected by pointing, the optical image converter signal when derived, including an indication of the pointing, wherein the processor is arranged to be responsive to the portion of the optical image converter signal including the pointing for causing the processor to process information associated with at least some of the other content in response to the pointed to graphical user interface element, as included in the signal.

10. The combination of claim 9 wherein the apparatus includes a pointer for selecting one of the graphical user interface elements, the signal when derived, including an indication of the location of the pointer, the processor being arranged to be responsive to the indication of the pointer location to cause the processor to process information associated with at least some of the other content of the document based on the location of the pointer on the selected graphical user interface element and the selected graphical user interface element.

11. The combination of claim 9 wherein the selected graphical user interface element is adapted to be selected by a finger of a user, and wherein the optical image converter is arranged so that the signal generated thereby includes an indication of the location of the finger, the processor being arranged to be responsive to the indication of the finger location to cause the processor to process information associated with at least some of the other content of the document based on the location of the finger on the selected graphical user interface element and the selected graphical user interface element.

12. The combination of claim 8 wherein the at least one graphical user interface element is printed in an area outside margins associated with the other content of the document, and wherein the processor is arranged to respond to graphical user interface elements only in the portion of the signal associated with regions outside the margin.

13. The combination of claim 12 wherein the document includes a plurality of distinct position indicating visual indicia adapted to be included in the signal, the processor being arranged to be responsive to the portion of the signal indicative of the position indicating indicia for determining the location of the area outside the location of the margin where the at least one graphical user interface element is located.

14. The combination of claim 8 wherein the at least one graphical user interface element is printed in an area inside margins including the other content of the document, the processor being arranged to process information associated with a portion of the other content adjacent the graphical user interface element.

15. Apparatus for use with plural documents, each including at least one graphical user interface element for controlling a computer function and other content, different graphical user interface elements being associated with controlling different computer functions, the apparatus comprising:
an optical image converter for generating a signal in response to optical images on the document, the signal representing the graphical user interface element and the other content of the document; and
a processor adapted to be responsive to the signal for processing information associated with at least some of the other content of the document based on a selected graphical user interface element of the document, as included in the signal.

16. The apparatus of claim 15 wherein the document includes a plurality of the graphical user interface elements, one of the graphical user interface elements being adapted to be selected by pointing, the optical image converter signal including an indication of the pointing, wherein the processor is adapted to be responsive to the portion of the optical image converter signal including the pointing for causing the processor to process information associated with at least some of the other content in response to the pointed to graphical user interface element, as included in the signal.

17. The apparatus of claim 16 wherein the apparatus includes a pointer for selecting one of the graphical user interface elements, the signal when derived, including an indication of the location of the pointer, the processor being arranged to be responsive to the indication of the pointer location to cause the processor to process information associated with at least some of the other content of the document based on the location of the pointer on the selected graphical user interface element and the selected graphical user interface element.

18. The apparatus of claim 16 wherein the selected graphical user interface element is adapted to be selected by a finger of a user, and wherein the optical image converter is arranged so that the signal generated thereby includes an indication of the location of the finger, the processor being arranged to be responsive to the indication of the finger location to cause the processor to process information associated with at least some of the other content of the document based on the location of the finger on the selected graphical user element interface and the selected graphical user interface element.

19. The apparatus of claim 15 wherein the at least one graphical user interface is printed in an area outside margins associated with the other content of the document, and wherein the processor is arranged to respond to graphical user interface elements only in the portion of the signal associated with regions outside the margin.

20. The apparatus of claim 19 wherein the document includes a plurality of distinct position indicating visual indicia adapted to be included in the signal, the processor being arranged to be responsive to the portion of the signal indicative of the position indicating indicia for determining the location of the area outside the location of the margin where the at least one graphical user interface element is located.

21. The apparatus of claim 15 wherein the at least one graphical user interface element is printed in an area inside margins including the other content of the document, the processor being arranged to process information associated with a portion of the other content adjacent the graphical user interface element.

22. A method of preparing a document including visual content to be processed by a computer and at least one graphical user interface element for controlling processing by the computer of information associated with the visual content, the method comprising the steps of
applying the visual content to the document, and
applying at least one graphical user interface element to the document, the at least one graphical user interface element being selected from a plurality of graphical user interface elements, each associated with a different function which can be performed by the computer on information associated with the visual content included in the document.

23. The method of claim 22 wherein the at least one graphical user interface element is applied to a portion of the document beyond margins of the visual content.

24. The process of claim 22 wherein the at least one graphical user interface element is applied to a portion of the document within margins of the visual content.

25. The method of claim 22 wherein a plurality of different graphical user interface elements are applied to the document.

26. The method of claim 22 further including applying subregions to the at least one graphical user interface element, the applied subregions being arranged for manual selection by application of a marking instrument.

27. The method of claim 22 further including applying distinct visual position indicating indicia to predetermined locations of the document, the location indicia being different from the visual content and the at least one graphical user interface element.

28. A document for use with a computer, the document comprising
at least one graphical user interface element, and
a visual content portion; the graphical user interface element being visually distinct from the visual content portion and being such as to provide information to the computer of how the computer is to process information associated with the visual content on the document.

29. The document of claim 28 wherein the document includes a plurality of the graphical user interface elements that are different from each other and associated with different processing functions by the computer of the information associated with the visual content included in the document.

30. The document of claim 29 wherein the at least one graphical user interface element is beyond margins on the document for the visual content.

31. The document of claim 30 wherein the document includes location indicia at predetermined locations of the document, the location indicia being different from the visual content and the at least one graphical user interface element.

32. The document of claim 29 wherein the at least one graphical user interface element is within margins on the document for the visual content.
